(19) United States
(12) Patent Application Publication
(10) Pub. No.: US 2006/0041450 A1
(43) Pub. Date: Feb. 23, 2006

(54) Electronic patient registration system

(76) Inventor: David Dugan, Lake Forest, IL (US)

Correspondence Address: Kenneth I. Kohn;KOHN & ASSOCIATES, PLLC, Suite 410, 30500 Northwestern Highway, Farmington Hills, MI, 48334, US

(21) Appl. No.: 10/922,408

(22) Filed: Aug. 19, 2004

(51) Int. Cl. G06Q 10/00

(52) U.S. Cl. 705/2

(57) ABSTRACT

According to the present invention, there is provided an electronic patient registration system and method including a registration mechanism and process for collecting user data, an authorization mechanism for eliciting user authorization and acknowledgment, and an indexing mechanism for organizing and associating the collected information. The present invention also provides for an electronic workflow regulation system and method, including a storage mechanism for recording patient information, a retrieval mechanism for accessing stored information, a management mechanism for updating and organizing patient information, and a backup mechanism for ensuring the integrity of patient information. Preferably, the present invention is directed towards a system, software program, and method for eliciting, receiving, organizing, and processing patient registration information in the health care field.

### BACKGROUND OF THE INVENTION

1. Field of the Invention

This invention generally relates to the field of electronic registration systems. Specifically, the invention relates to a system used for electronic patient registration, information processing, and business process management.

2. Description of Related Art

Physicians and other medical office personnel are responsible for obtaining patient background information (e.g., name, address, insurance, emergency contacts and other background information), medical information (e.g., personal medical history, history of present illness, social history, family history, review of systems, etc.) and patient signatures to key authorizations and authorization forms (e.g., HIPAA Acknowledgement, Financial Responsibility, Release of Records, Advanced Beneficiary Notice and others). The vast majority of medical providers utilize hard copy forms to obtain this information upon arrival of a patient at a medical practice. Additionally, the patient experience is burdened by repeat entry of redundant information, and requirements that such information must be provided manually again if the patient has not been seen by the practice for some time (e.g., 6 months to a year), or if the practice is converting to a new system. Patient responses can be incomplete, inaccurate or illegible, further compounding the cost, time, and delay in providing patient care.

An additional barrier to operational efficiency in medical offices and practices has been the wealth of external and internal documents, which are traditionally photocopied and manually kept in a paper based medical file (i.e., insurance card and ID card copies, referrals, prescriptions, lab orders, insurance authorizations, etc.). The costs of copying, filing, retrieving, re-producing and mailing, sharing or otherwise syndicating access to such documents has been a longstanding problem for the medical industry. Providers operating across campus settings or one or more geographically dispersed offices, hospitals, surgical centers or remote mobile/ambulatory care units have an inability to access such hardcopy records, or must incur substantial costs for retrieval, reproduction and physical distribution of these records. Additionally, the need to exchange data via EDI under HIPAA compliant guidelines for health care claims and claim payment/advice will become mandatory in the future with a growing number of payors including Medicare and Medicaid.

Patient privacy and security of information has also been highlighted (HIPAA and other regulations and requirements) as a key need for the industry. Non-modifiable, edited patient entries and the original raw patient entries into an encrypted, permanently stored electronic medical record can serve to reduce practice risk by ensuring that all patient responses and updates can be documented and permanently stored to create a permanent audit trail. Patient data accuracy can be improved through dynamic and configurable clinical and demographic questions that are editable and time stamped for accuracy and completeness.

Accordingly, there is a need for a method and system for electronic patient registration and external/internal document processing that provides for decreased time, risk and effort required of the physician or other medical office personnel, and the patient to review, edit, index, copy, file, re-produce and otherwise manage this data onto the medical file, while increasing timeliness, accuracy and ease of access to the physician or other medical office personnel.

### SUMMARY OF THE INVENTION

According to the present invention, there is provided an electronic patient registration system and method including a registration mechanism for collecting user data, an authorization mechanism for eliciting user authorization and acknowledgment, and an indexing mechanism for organizing and associating the collected information. The present invention also provides an electronic workflow regulation system, including a storage mechanism for recording patient information, a retrieval mechanism for accessing stored information, a management mechanism for updating, organizing, and auditing patient information, a presentation mechanism for presenting patient data, and a backup and restore mechanism for ensuring the integrity of patient information. Preferably, the present invention is directed towards a system, software program, and method for eliciting, receiving, organizing, and processing patient registration information and medical records in the health care field.

### DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram of the present invention;

FIG. 2 is a process flow diagram for the web-based registration system;

FIG. 3 is a process flow diagram for the on-site registration system;

FIG. 4 shows an example of a graphical user interface of the web-based registration system;

FIG. 5 shows an example of a graphical user interface of the on-site patient registration system;

FIG. 6 is a technical diagram depicting electronic document processing and auto-indexing solutions;

FIG. 7 is a process flow diagram for the workflow processing system, either at the provider site or by an outsource solutions provider;

FIG. 8 is a process flow diagram for the connection integrity monitor; and—

FIG. 9 is a process flow diagram for the paper based registration system.

### DETAILED DESCRIPTION OF THE INVENTION

Generally, the present invention provides a method and system for permitting patients to perform registration for their medical provider(s), in particular, using either secured web-based electronic registration, as well as tablet or Pen-Tablet PC based registration at the provider facilities. The tablet and Pen-Tablet PC computers communicate either via wireless or wired connections to a central data server containing comprehensive electronic medical records.

The present invention creates a method to utilize web based registration and/or electronic patient registration at the provider site to create a turnkey integrated solution to address these issues, and to provide a complete registration and editing system to support the clinical and financial requirements of the healthcare provider.

The term “registration” as used herein means, but is not limited to, the solicitation and input of patient background/demographic information (e.g., name, address, emergency contacts and other background information), medical information (e.g., personal medical history, history of present illness, social history, family history, review of symptoms, etc.), and insurance information (insurance provider, policy number, etc.).

The term “authorization” as used herein means, but is not limited to, the solicitation and input of patient signatures for legal authorization for the delivery of medical care, transfer of records, release of records, and other such legal authorizations.

The term “acknowledgment” as used herein means, but is not limited to the solicitation and input of patient signatures for acknowledging the delivery of medical care, HIPAA Acknowledgement, Financial Responsibility, Release of Records, Advanced Beneficiary Notice and other such acknowledgments.

The terms “information” and “data” as used herein means any answer responding to a prompted or elicited request for information. The answer includes, but is not limited to demographic information, personal patient information, insurance information, identification, symptoms, descriptions, and any other information relating to the patient, the patient's medical record, and the patient's medical care.

The term “user(s)” as used herein is meant to include, but is not limited to, patients, clients, health care providers, medical office personnel, lawyers, billing and accounting personnel, insurance company personnel, patient, and any other similar individuals who utilize the systems and methods disclosed herein.

The term “graphical user interface” as used herein is meant to include, but is not limited to, a graphical representation of a series of forms for eliciting and receiving patient information.

The term “forms” as used herein is meant to include, but is not limited to, a virtual interactive document containing queries and spaces for the input of responses. Some queries, i.e., the request for a patient's name, allow for all possible user responses, using an input device such as a Tablet/Pen-Tablet PC, a keyboard, a touch-screen, or a voice recognition device. Other queries, i.e., the name of the patient's insurance company, provide the user with a menu of several appropriate responses from which to choose.

The term “storage” as used herein means, but is not limited to, the recording of elicited data onto a recordable memory device, such as hard disk, CD-ROM, CD-RW, DVD-ROM, DVD-RW, floppy disk, flash memory, tape drive, remote server (i.e., ASP provisioned, Hosted or Enterprise Managed), local server, or any other data storage device.

The term “communication interface” as used herein is meant to include, but is not limited to, Internet, Intranet, Extranet, and wireless networks.

The term “obtaining” as used herein means, but is not limited to, the receipt and capture of digital patient signatures, initials, photographic or document images, and other such seals of approval, authorization, and acknowledgement.

The terms “indexing” and “associating” as used herein are meant to include, but are not limited to the logical ordering and prioritizing of inputted information within the patient's medical record or other relevant information groupings, and the linking of inputted information with other pieces of information, respectively. Examples of indexing include, but are not limited to, the ordering of patient visits by date, location, symptoms, or other such criteria. Examples of associating include, but are not limited to, the linking of a patient's insurance policy number with the patient's insurance provider, and the associating of the patient's registration at the physician's clinic with the queue of patients waiting to been seen by the physician, as well as the queue for patient visits to be billed.

The term “retrieving” as used herein means, but is not limited to, the recall and presentation of previously inputted patient information, such as personal information, test results, insurance and billing information, digital signature information, digital images, and all other parts of the patient's medical record and chart.

The term “customizing” as used herein means, but is not limited to, the editing and modifying of system features, sequences, and functions, to better serve the user. For example, modifying the graphical presentation, questions asked, potential answers presented, sequence of questions presented, and other settings and features

The term “highlighting” as used herein means, but is not limited to, the marking of data based on its input date, input location, level of severity, party responsible for, or any other user-selected criteria.

The term “workflow” as used herein means, but is not limited to, the managing of the relevant events associated with the processing and administration of medical care and financial obligations. For example, the registration of a patient's arrival at a medical facility, the alerting of the office staff that the patient has successfully registered, the retrieval of the patients' electronic medical record, the review and editing of the patients' record, the patient's visit, the recording of notes, diagnosis, and treatment to the patients' electronic record, the alerting of the appropriate providers of such diagnosis and treatment, and the billing to the insurance company of the visit, tests, and other associated costs.

The term “management” as used herein means, but is not limited to, the monitoring of the integrity between remote user devices and the central server, synchronizing the information communicated between the remote device and the central server, detecting data conflicts, and assigning such conflicts to the appropriate defined resource.

The present invention is utilized for numerous reasons and in numerous settings. The present invention relates to various processes that include, but are not limited to, registration, authorization, data storage, data indexing, data retrieval, data transfer, billing, accounting, workflow processing, and any other process that relates to registration, electronic record keeping, and workflow processing. Preferably though, the present invention is well suited for use in medical practices with regard to patient registration and medical records by integrating electronic record keeping, and workflow processing.

The present invention is utilized in numerous settings and fields. Although the preferred embodiment of the present invention is for use in the health care field, the present invention is operable in fields including, but not limited to, law engineering, accounting, businesses, and any other fields needing registration, record keeping, and workflow processing systems and methods as described herein. In particular, the present invention is well suited in fields requiring conducting periodic registrations, fields requiring the storage and access by multiple parties of comprehensive records, and the management of a service delivery process by multiple parties.

The present invention generally operates through the use of information eliciting forms that are specifically tailored towards specific areas of medical or business specialties. Because the present invention is fully customizable and adaptable for eliciting the specific information desired by the provider, it provides specific information eliciting functions relating to any medical specialty such as cardiology, internal medicine, neurology, and family practice. Moreover, the present invention is fully expandable for use in settings requiring enormous data collection and documentation including, but not limited to, hospitals, medical offices, medical clinics, business offices, service centers, and any other similar business or medical settings.

The present invention is accessible through any device possessing the appropriate hardware capable of operating the system of the present invention. Appropriate devices include, but are not limited to, Tablet/Pen-Tablet PC's, hand-held devices, portable computers, desktop computers, wireless devices, web-based technology systems, touch screen devices, typing devices, and any other similar electronic device that allows the entry of information known to those of skill in the art. Entry of information occurs through input devices including, but not limited to, keyboards, electronic pens together with handwriting recognition software, mouse devices, touch-screen devices, microphones together with voice recognition and voice command software, scanners, and any other similar electronic input devices known to those of skill in the art.

The present invention works independently on a single device, and also works in unison with other networked devices. Thus, wired or wireless transmission from the device to a common server is possible. The data is stored on the device itself, a local server, a central server via the Internet, or a central data warehouse outside of a facility. The present invention allows for simultaneous, multiple users.

Other functions and aspects of the registration system of the present invention include, but are not limited to, interfaces for eliciting patient information and signatures, data storage and backup mechanisms, data indexing mechanisms, security mechanisms, and synchronization mechanisms for synchronizing and transferring data between the central server and a remote device. Additionally, the present invention features a customization mechanism that customizes the look, feel, content, sequence, and operation of the entire registration system.

The present invention includes a software program for all of the functions of the registration system, including information solicitation and input, information communication and storage, information access, information organization, and information processing.

The software program is accessible through communication systems including, but not limited to, the Internet, Intranet, Extranet, and any other similar electronic mechanism know to those of skill in the art. Additionally, the software is capable of being interfaced and integrated with currently existing software programs such as Microsoft Office, Microsoft Outlook, QuickBooks, and other such business software programs, as well as existing medical record keeping and processing programs and systems.

In operation, the registration system involves a method including the steps of: collecting user data, eliciting user authorization and acknowledgment, storing the collected information, and organizing the information, both past and present.

The registration method generally includes navigating through various information prompting forms containing queries relevant to a patient visit. The user inputs the relevant information into these forms. The input of this information can occur either on-site, using a local device, or remotely, using a remote PC connected to the Internet. All inputted information is saved locally, and is also communicated to a central server. Any newly inputted information is associated and indexed with the patient's existing electronic record.

Once the user has inputted the relevant information, the user is prompted to sign various authorization and acknowledgement forms. The patient signatures are captured using a Pen-Tablet/Tablet PC device with handwriting capture software. The signatures are obtained on-site, using a local Pen-Tablet or Tablet PC, or remotely, via the user's own Pen-Tablet or Tablet PC device. The date, time, and location of the signing are also recorded and associated with the digital signatures. The digital signatures and related information are stored locally on the Pen-Tablet/Tablet PC device, and are also communicated to a central server and are stored and associated with the patient's existing medical record. The signatures are stored in a non-modifiable, encrypted format, thereby ensuring their integrity and privacy.

All user inputs, including all patient data and signatures, are replicated on the local device and across one or more server(s) and mirrored computer storage arrays to assure reliability and business continuity.

The registration system further includes a method and system for electronic document scanning and automatic indexing for logical association to the patient's electronic medical chart, including the steps of: scanning the relevant documents, converting the documents into a digital graphic file, storing the graphic file on the local device and on the central server, indexing and associating the graphic file with the patient's electronic medical record, analyzing the graphic file for relevant patient data, recording the relevant data into the patient's electronic record, as well as zooming, cropping, and otherwise manipulating the digital graphic file.

Although there are numerous embodiments of the present invention, the preferred embodiment is directed towards improved efficiency, accuracy, mobility, and connectivity of medical records, delivery of medical treatment, medical office workflow processing and billing, and patient care.

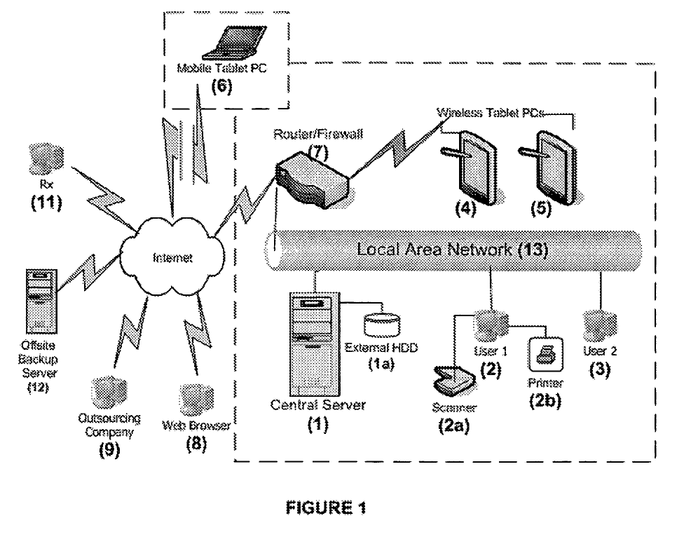

In one embodiment, a typical configuration of the present invention is set forth in FIG. 1. The present invention employs a central server (1) that includes central Database (i.e., SQL Server, Exchange Server and IIS). An external storage device (i.e., tape drive, etc.) (1a) is also employed for data backup purposes. User 1 (2) is a regular PC with an operating system (i.e., Windows XP, Linux, etc.), used by receptionist/schedule coordinator to connect to the central server via wired local area network (13). A scanner (2a) to scan external documents (i.e., insurance card, identification card, prescription, etc.) is connected to the receptionist's PC, as is a printer (2b) to print documents generated from information residing on the central server. User 2 (3) is a regular PC with an operating system (i.e., Windows XP, Linux, etc.), used by Billing Personnel/Administrators to connect to the central server (1) via wired local area network (13). A Wireless tablet/Pen-Tablet PC (4) connects to the local area network wirelessly with 128 bit data encryption and MAC filtering for enhanced security, and is used by Physicians/medical personnel for information retrieval and input. Another Wireless Tablet/Pen-Tablet PC (5) connects to the local area network wirelessly with 128 bit data encryption and MAC filtering for enhanced security, and is used by the patient for information input. A mobile tablet/Pen-Tablet PC (6) connects to the system via the Internet, and is used by Physicians/medical Personnel at remote locations, (i.e., hospitals, surgical centers, at Home, while traveling, etc.). This mobile tablet/Pen-Tablet PC also operates independently, when not connected to the Internet. When operating independently, the mobile tablet/Pen-Tablet device synchronizes its data with the central server upon being re-connected to the Internet. A Router/Firewall (7) protects network computers from hackers/worms and also helps wireless computers connect to the local network. A remote PC with a web browser (8) connects to the system via the Internet, and is used for patient e-registration via provider's secured website. A remote outsourcing company (9) also connects to the system via the Internet, to review and process inputted information. Rx (11) is a pharmacy or pharmacy network to which prescriptions are sent electronically. An offsite backup server (12) connects to the system via the Internet, providing remote business continuity services and protecting clients from business disruption risks.

In a preferred embodiment, the patient accesses the system at the medical office using a Pen-Tablet/Tablet PC device (see FIG. 1 at (5)). Alternatively, the patient accesses the system from a remote computer, using a web browser and a computer connected to the Internet (see FIG. 1 at (8)). In accessing the system from a remote computer, the patient avoids the need to register once he/she arrives at the medical office, thereby increasing efficiency and the overall patient care experience.

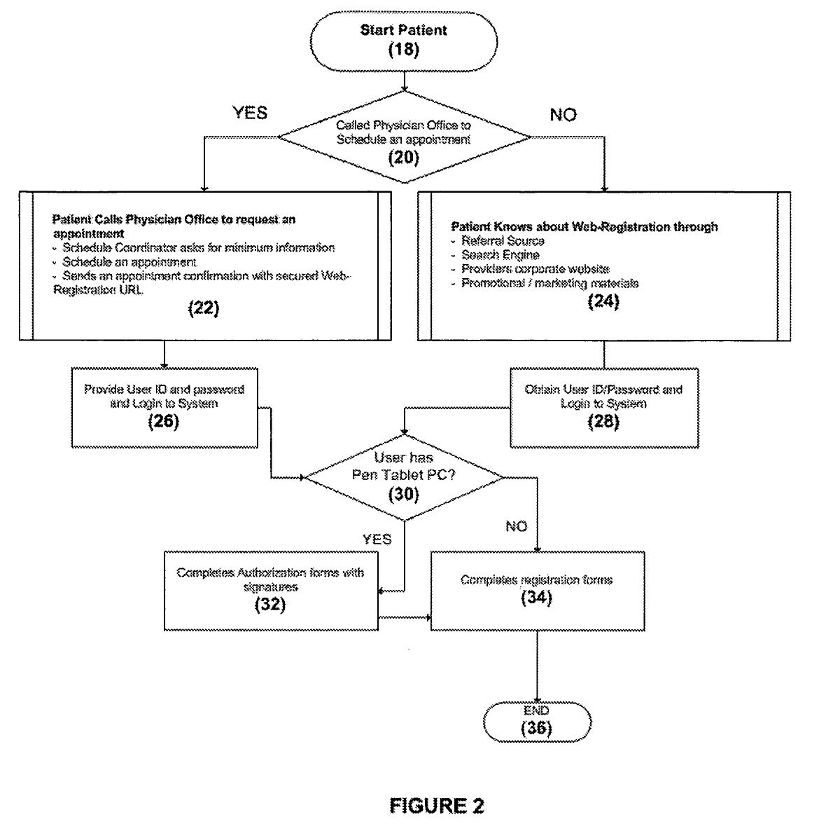

FIG. 2 represents a process flow diagram of the remote web-based registration system. The patient initiates (18) the registration process (20) either by calling the Physician's office to schedule an appointment (22) or through logging directly onto the system (i.e., through health care provider's website) (24). If the patient has called Physician's office to schedule an appointment, the patient is given a User ID and password to access the system (26). Otherwise, the patient obtains a User ID and password via the provider's secure website (28). The patient then logs onto the system (26, 28), which determines whether the patient has a tablet/Pen-Tablet PC (30). If the patient has a tablet/Pen-Tablet PC, the patient signs the relevant authorization forms (32) and inputs the relevant registration information (i.e., personal information, medical history, etc.) (34), thereby completing the web-registration (36). Otherwise, the patient inputs the relevant registration information (i.e. personal information, medical history, etc.) (34), thereby completing the web-registration (36).

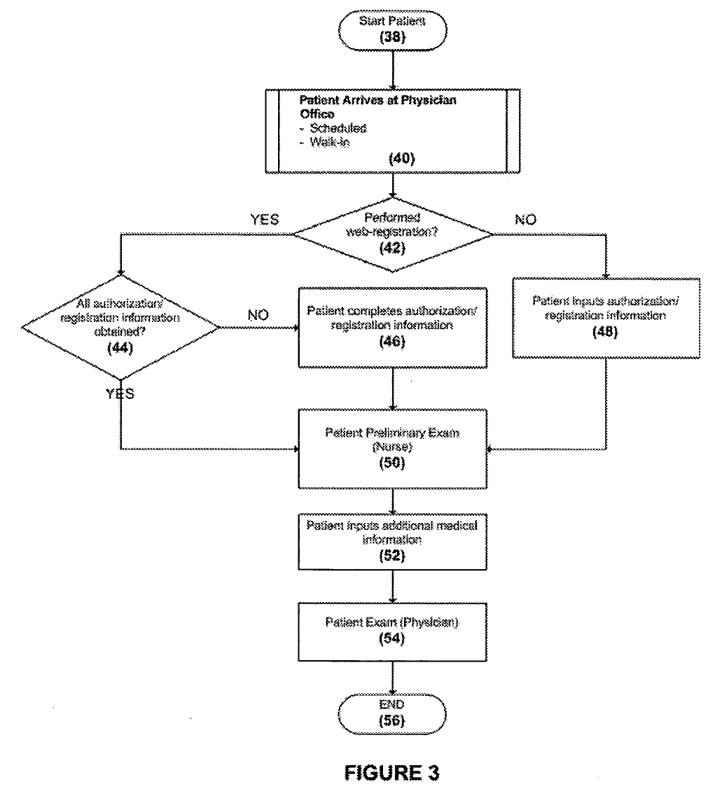

FIG. 3 represents a process flow diagram of the on-site registration system. The patient (38) arrives at the Physicians office (for either a scheduled or a walk-in appointment) (40) and the system determines whether the patient has performed a web-based registration (42). If the patient has performed the web-based registration, the system determines whether all necessary authorization and registration information has been obtained (44). If it has, the patient proceeds to the preliminary medical exam (50). Otherwise, the patient inputs the remaining authorization/registration information (46) and proceeds to the preliminary exam (50). If the patient has not performed the web-based registration, the patient completes the authorization and registration processes (48) and proceeds to the preliminary medical exam (50). After the preliminary medical exam, the patient is prompted to input additional relevant medical information (52). The patient then proceeds to the medical exam with the physician (54), thereby completing the process (56).

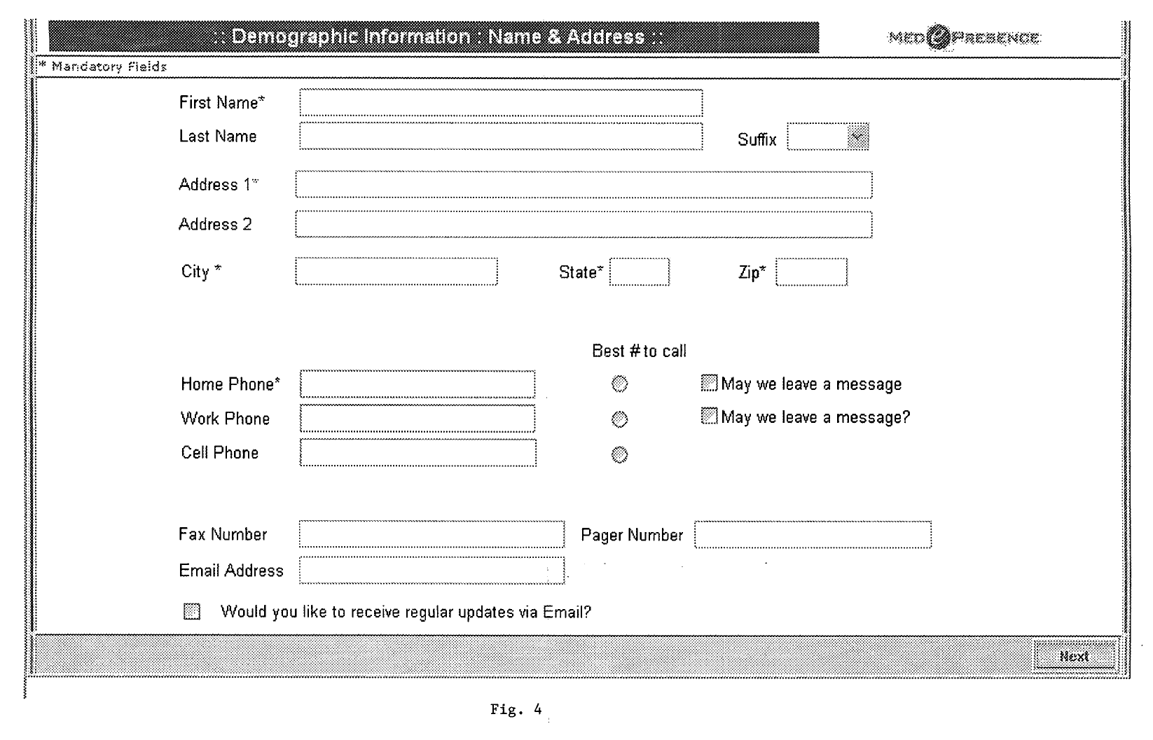

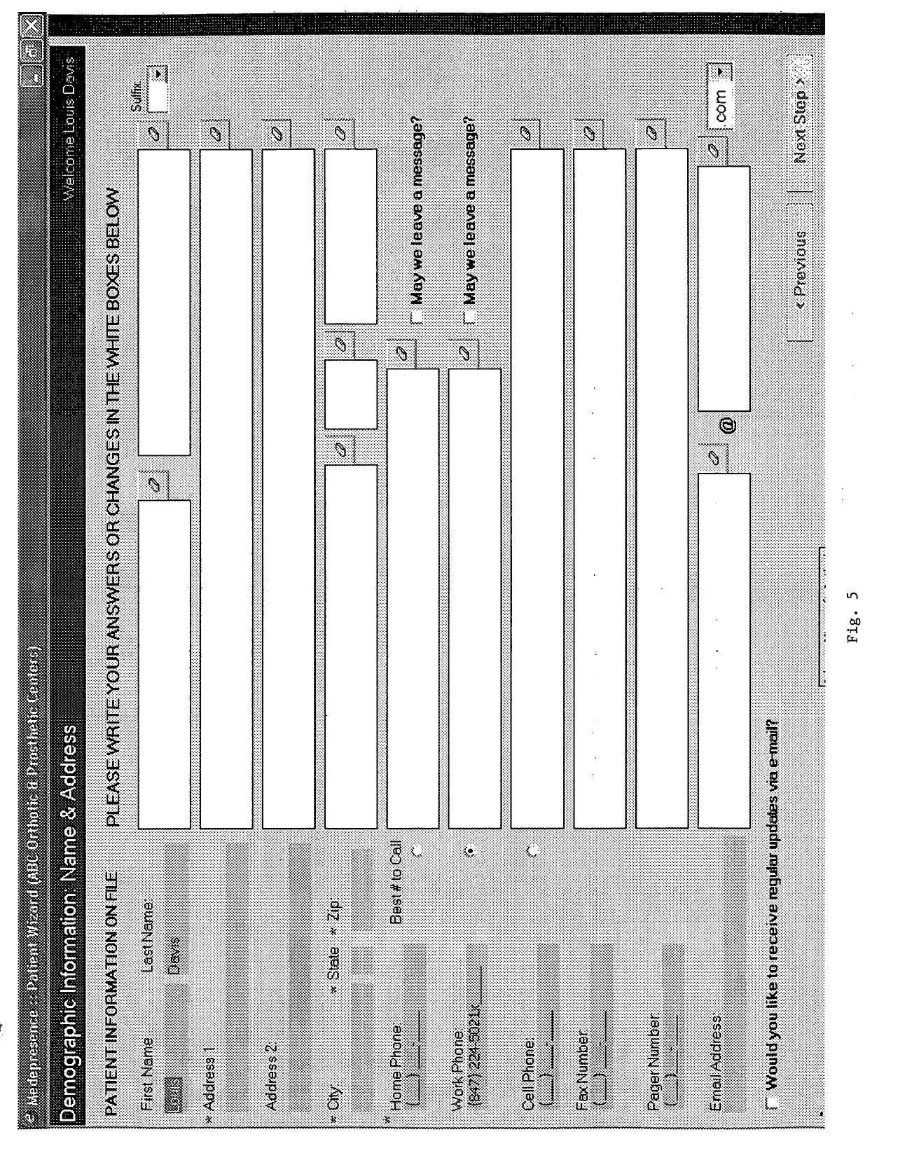

The registration system operates by presenting the patient with a series of forms, and requesting specific personal information (i.e., name, address, phone number, etc.), administrative information (i.e., insurance company, policy number, etc.), and medical information (i.e., medical history, allergies, symptoms, etc.) from the patient (FIG. 4, FIG. 5). The patient inputs this information using an electronic pen device with handwriting capture technology, pull down menus, point-and-click buttons, keyboard, mouse, microphone with voice recognition software, and other such input devices known to those of skill in the art. The inputted information is stored locally, on the device being used, and is also transmitted to and synchronized with a central server containing the patient's electronic medical record. Additionally, the date, time, location, and identity of the user and the information input is recorded together with the inputted information, thereby creating an audit trail. This audit trail allows for conflict detection (if one part of the inputted information conflicts with another portion of the patient's record), and automatic error correction.

All forms and menus that the patient is presented with are fully customizable based on several criteria. Thus, the system can be customized to elicit information specific to a particular medical specialty (i.e., neurology, cardiology, etc.). Additionally, the system can be customized to request only information relevant to the patient's visit (i.e., the system does not request the patient's date of birth during a repeat or follow-up visit). The system also automatically detects (based on the patient's medical record, and the stated reason for the visit) what information is relevant to the medical provider (i.e., continuation of symptoms from a prior visit), and accordingly elicits this information from the patient. By automatically targeting the relevant information to elicit, the system increases efficiency in processing patient registration, reduces the occurrence of error and redundancy, and focuses the nature of the care delivered to the patient. The system also supports multi-lingual capabilities to enhance understanding by patients and to increase the accuracy of the furnished responses.

The system operates in a similar fashion in a follow-up appointment setting. When a patient arrives at the health care provider for a follow-up visit, they are presented with forms containing the information (personal, medical, etc.) inputted previously. The user is prompted to modify this information (i.e., change in address, change in insurance provider, etc.) or update the information (i.e., change in prior symptoms, change in diet, etc.). If no modification or update is necessary, the user simply indicates that the information has not changed.

If the user has modified or updated any information, the system automatically detects these changes, and highlights them accordingly. The highlighted information is then reported to the health-care provider for review. This system allows the health care provider to immediately target the information necessary to monitor the patient's care, and to provide efficient and focused health care. Additionally, the system organizes the patient responses into a permanent, non-modifiable history of all patient responses across all encounters with the medical practice. This support provides proactive, preventative risk remediation, as well as streamlined, cost effective documentation of all patient furnished information which is important in both clinical care of the patient, operational workflow to deliver medical care, and enhanced billing efficiency, accuracy, and timeliness.

Once the patient has finished inputting all relevant information into the system, the patient is presented with a series of forms for authorization and acknowledgement. Alternatively, the patient is presented with the authorization and acknowledgement forms prior to inputting his/her patient information. The patient is presented with these forms, and is given the opportunity to review them. Once the patient has reviewed and agreed to the terms of these forms, the patient affixes his/her digital signature on the provided digital signature line, using an electronic pen and a Pen-Tablet/Tablet PC device. This signing occurs either on-site, at the medical provider's location, or remotely, if the patient has a Tablet/Pen-Tablet PC connected to the Internet. The patient's digital signature is captured, together with the time, date, location, and identity of the signing. This information is stored locally, on the Tablet/Pen-Tablet device, and is also communicated to a central server where it is associated and indexed with the patient's existing medical record.

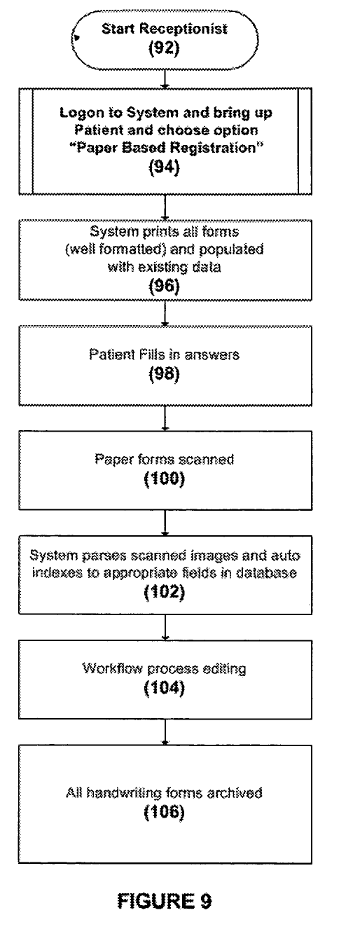

The patient registration process can also be implemented using paper forms and optical scanner technology. FIG. 9 represents a process flow diagram of the paper-based registration system. The process begins when a receptionist (or other such health care personnel) (92) logs onto the registration system, selects a given patient from the system, and indicates that paper based registration will be performed (94). Alternatively, the receptionist logs onto the system, and indicates that a new patient will register using paper based registration. The system then retrieves all necessary forms to be completed by the patient, and populates these forms with pre-existing data from the patient's electronic medical record. These forms are then printed (96) using a printing device. Alternatively, the system can also process pre-existing medical registration forms that are not generated by the system.

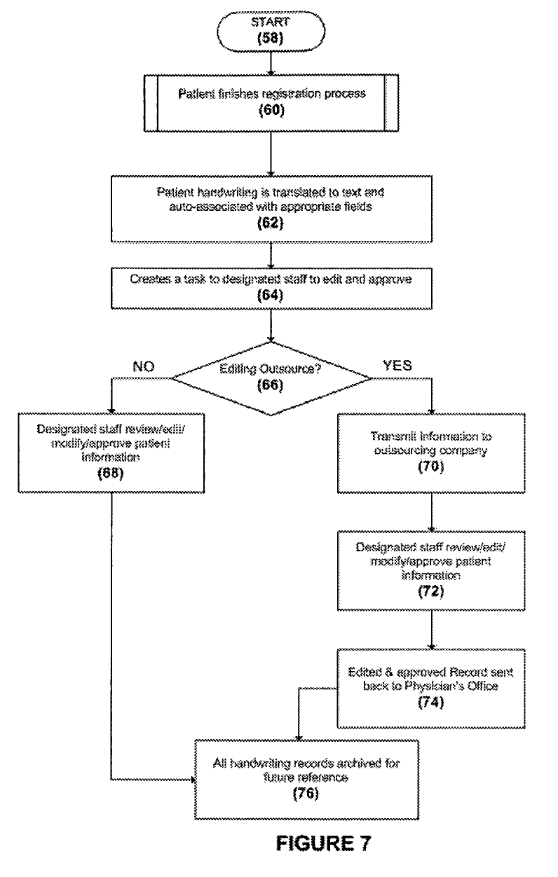

The patient is presented with the printed forms, and proceeds to complete the forms using a writing implement (98). The patient also modifies and corrects any pre-existing data included on the forms. When the patient has completed all relevant paper forms, the forms are scanned (100) using an optical scanner, or any other such digital image capture device. The system then converts the image to digital format, translates the patient responses (using intelligent character recognition (ICR) technology), parses the relevant data, and auto-indexes the data to the patient's electronic medical record (102). The scanned images of the completed forms are also stored and associated with the patient's electronic record. The converted patient registration data, as well as the scanned forms, are then transmitted to the workflow processing system (see FIG. 7) for editing (104). All patient responses and forms are archived and stored together with the patient's electronic medical record (106). Additionally, the time, date, location, and identity of the registration, scanning, etc. is recorded and auto-indexed with the data.

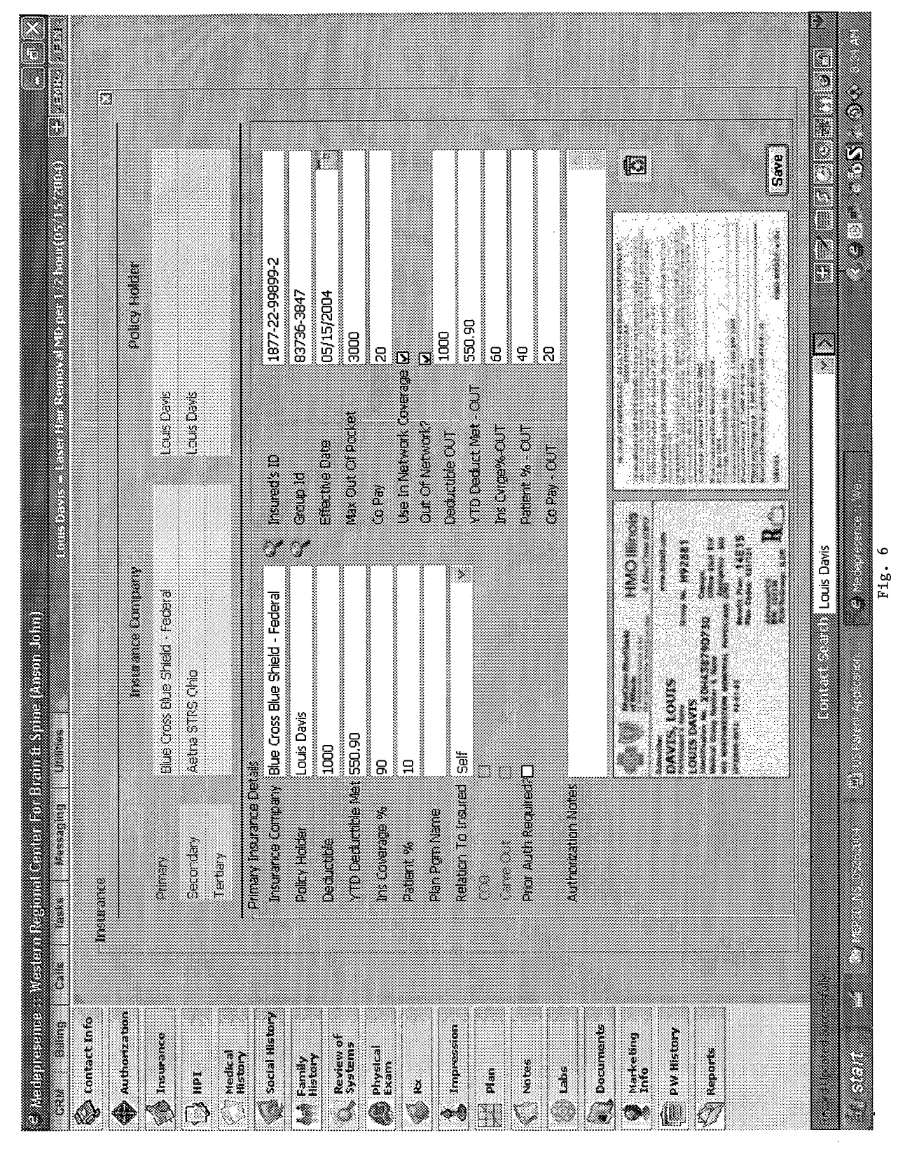

The system additionally provides for document scanning, converting of the scanned documents, and indexing the documents with the patient's medical record (FIG. 6). In the course of providing medical care, many forms and documents are necessary, such as proof of identification (e.g., driver's license, passport, etc.), proof of insurance (e.g., insurance card, etc.), prescriptions, and other such documents. These documents are scanned into the system using a flatbed or form-fed scanner (see FIG. 1 at (2a)), digital camera, or other such image capture devices known to those of skill in the art. Once captured, the documents are converted into digital graphic format (i.e., .jpg, .gif, .bmp, etc.), and are auto-indexed together with the patient's electronic medical record. Additionally, the graphic file is scanned and read using OCR (Optical Character Recognition) technology and parsed for relevant information (such as driver's license number, insurance policy number, etc.), and this information is stored and associated with the patient's electronic medical record (FIG. 6). Additionally, the system provides for zooming, cropping, and otherwise manipulating the digital graphic files and print hard copy. The time, date, location, and identity of the scanned documents is also recorded. This information is associated, and indexed with the graphic files per se, as well as with the patient's electronic medical record. A document audit trail is thereby created in the patient's electronic record, containing images of the scanned documents, as well as the time, date, location, and identity of the scanning and conversion. This system thereby reduces the time, risk, and effort required to review, index, copy, and otherwise manage external documents needed in the patient's medical file. Additionally, the system allows the physician and other medical office personnel to quickly and accurately access the scanned documents across multiple provider locations and patient visits. The audit trail also allows for greater accuracy and comprehensiveness in medical record keeping.

Once the patient has completed the registration process, the information furnished by the patient is sent through a workflow processing system for reviewing, editing, and approving the patient information. This system collects all newly inputted patient information, and presents the information to the health care provider, either within the graphical user interface of the system itself, or via another electronic data communication mechanism (such as email, fax, print, etc.). The information is then reviewed by the applicable health care personnel (either on-site or outsourced), edited if necessary, and then approved by the reviewer. This system thereby allows efficient and timely reviewing, editing, and processing of patient registration and documentation, and allows this review to occur immediately at any remote location. The system records the date, time, location, and identity of the information review/edit, and stores this information together with the patient's electronic medical record.

FIG. 7 represents a process flow diagram of the workflow processing system. Once the patient (58) completes the entire registration process (60), all inputted handwritten text is translated by the system (using handwriting recognition software), and auto-associated to the appropriate field (62). The system then creates a task for the designated staff to edit and approve the inputted patient information (64). The system then determines whether the editing and approval tasks are to be outsourced (66). If these tasks are to be outsourced, the system transmits the inputted data to the outsourcing company (70). The outsourcing company then reviews, edits, and modifies the patient data, specifically checking for any errors in the systems' handwriting translation (72). The edited and approved information is then transmitted back to the Physician's office (74). If the editing and approval is not to be outsourced, the designated staff at the Physician's office reviews, edits, and modifies the inputted patient information (68). Ultimately, all handwritten text records are archived together with the patient's medical record for future reference (76).

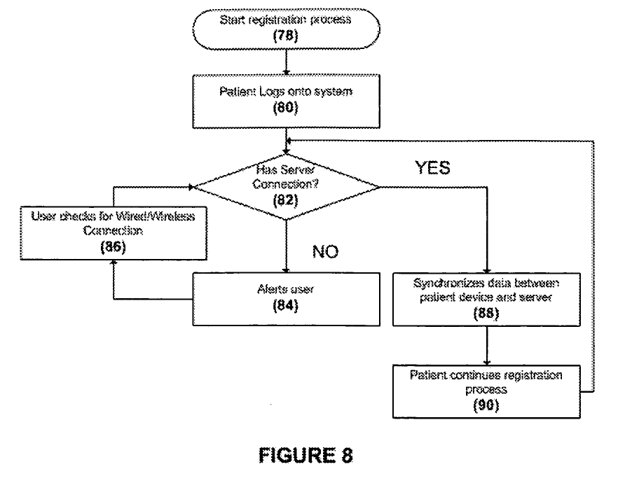

The system additionally provides for a connection integrity monitor to manage the connection between remote devices and the central server (FIG. 8). The connection integrity monitor also routinely synchronizes the information inputted to the device with the information contained on the central server, thus ensuring the integrity and consistency of the patient record. Furthermore, the connection integrity monitor constantly monitors the integrity of the data contained on the remote device and the data contained on the central server. If the connection integrity monitor detects a data conflict within information stored on the central server, information stored on the remote device, or a conflict between data on the remote device and data on the central server, an alert is triggered. This alert can take the form of an email to an administrator, a pop-up message box, or other such digital alert mechanisms known to those of skill in the art. Alternatively, the system can be customized to automatically correct certain data conflicts.

FIG. 8 represents a process flow diagram of the connection integrity monitor. The patient begins the registration process (78) by logging onto the system (80). The system then determines whether a server connection is present (82). If a connection is present, the system synchronizes the data between the patient's device and the central server (88). The patient then continues the registration process (90), while the system continuously monitors whether a server connection is present (82). If a server connection is not present, the system alerts the patient that a connection is not present (84), and the user checks for a wired/wireless connection (86). The system then continues to monitor whether a server connection is present (82).

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. An electronic patient registration system comprising registration means for collecting user data, authorization means for eliciting user authorization and acknowledgment, and indexing means for organizing and associating the collected information.

2. The system according to claim 1, wherein said registration means includes a secure web-based registration site for remote patient registration and information input.

3. The system according to claim 2, further including eliciting means for eliciting patient signatures for authorization and acknowledgment.

4. The system according to claim 3, wherein said authorization or eliciting means is selected from the group including Pen-Tablet or tablet PC devices.

5. The system according to claim 1 including a software program for on-site patient registration and information input.

6. The system according to claim 5, wherein said software program includes a graphical user interface for user interaction and information input and forms for eliciting patient information.

7. The system according to claim 5, wherein said software program is implemented on a device selected from the group consisting essentially of Tablet PC's, Pen-Tablet PC's, hand-held devices, portable computers, desktop computers, wireless devices, web based technology systems, touch screen devices, typing devices, and electronic devices.

8. The system according to claim 5 including means for patient data entry.

9. The system according to claim 8, wherein said data entry means include Tablet or Pen-Tablet PC's with electronic handwriting recognition software, keyboard, mouse (point and click), touch screen, and a microphone equipped with voice recognition and voice command software.

10. The system according to claim 8, wherein said data entry means further includes a system for generating and printing registration forms, recording patient data onto said forms, digitally scanning and capturing said forms, translating, and parsing data from said forms, indexing and associating data from said forms, and archiving all information relating to said forms.

11. The system according to claim 1 including storage means for recording and accessing patient data and input.

12. The system according to claim 11, wherein said storage means is further defined as a central server.

13. The system according to claim 1 including a communication interface for data transfer between remote users and the central server.

14. The system according to claim 13, wherein said communication interface includes Internet, Intranet, Extranet, and wireless networks.

15. The system according to claim 1 including obtaining means for collecting secured, digital, non-modifiable signatures, indexing means for associating digital signatures with a patient's record, retrieving means for recalling digital signatures, and electronic means for transferring digital signatures.

16. The system according to claim 15, wherein said obtaining means includes a software program for eliciting and storing digital, non-modifiable signatures.

17. The system according to claim 15, wherein said indexing means includes a software program for indexing and associating the signatures with the patient's existing electronic record.

18. The system according to claim 15, wherein said retrieving means includes a software program for recalling and presenting the digital signatures.

19. The system according to claim 15, wherein said transferring means includes a software program for transferring digital signature information.

20. The system according to claim 15, further including means for viewing, printing, emailing, and faxing said signatures and other patient information.

21. The system according to claim 1 including capturing means for digitally scanning documents and images, converting means for converting said documents and images into digital graphic format, indexing means for associating digital graphic files with a patient's medical record, parsing means for extracting relevant information from digital graphic files, and manipulation means for manipulating digital graphic files.

22. The system according to claim 21, wherein said capturing means includes flat-bed scanners, form-fed scanners, digital cameras, and other such digital image capture devices.

23. The system according to claim 21, wherein said converting means includes a software program for creating digital images.

24. The system according to claim 21, wherein said indexing means includes a software program for indexing and associating the digital images with the patient's existing electronic record.

25. The system according to claim 21, wherein said parsing means includes a software program for optical character recognition and information extraction.

26. The system according to claim 21, wherein said manipulation means includes a software program for zooming, cropping, and otherwise manipulating digital graphic files.

27. The system according to claim 21, further including recording means, for recording the time, date, location, identity, and other such information relating to document and image scanning.

28. The system according to claim 21, further including means for viewing, printing, emailing, and faxing said digital graphic files and information relating to said files.

29. The system according to claim 1 including a customizable software program for presenting and updating existing patient data, and means for entering new patient data.

30. The software program according to claim 29, wherein said customizable software program elicits only the relevant information from the patient.

31. The software program according to claim 29 including a configuration tool for customizing the system.

32. The software program according to claim 31, wherein said configuration tool customizes the appearance, requirements, and sequencing of the system, and also defines the information to be elicited from the patient.

33. The software program according to claim 31, wherein said configuration tool customizes the domain range of valid patient responses.

34. The software program according to claim 29, including automatic indexing means for associating patient data with the patient's electronic record.

35. The software program according to claim 29, including means for viewing, printing, emailing, and faxing said data and other patient information.

36. The software program according to claim 29, including updating means for eliciting periodic updates of patient information.

37. The software program according to claim 29, including highlighting means for highlighting newly entered or modified patient information.

38. An electronic record-keeping and workflow regulation system, comprising storage means for recording patient information, retrieval means for accessing stored information, management means for updating and organizing patient information, and backup means for ensuring the integrity of patient information.

39. The system according to claim 38, wherein said storage means includes local storage on remote device and storage on a central server.

40. The system according to claim 38, wherein said management means includes a connection integrity monitor to manage the connection between remote devices and the central server.

41. The system according to claim 38, wherein said management means further includes a software program for replicating and synchronizing the information communicated between the remote device and the central server.

42. The system according to claim 38, wherein said management means further includes a software program for detecting data conflicts.

43. The system according to claim 42, wherein said software program assigns conflicts to the appropriate defined resource.

44. The system according to claim 38, wherein said backup means includes a software program for managing remote backup of data and configuration information.

45. A workflow processing method comprising the steps of: reviewing the inputted patient data; editing the data; marking the data as reviewed; forwarding the data to another party; and responding to data alerts.

46. The method according to claim 45, wherein said marking step is defined as marking the identity of the inputting and reviewing parties and the time/date/location of the input/review.

47. A system for recording and indexing all patient registrations.

48. The system according to claim 47 including means for recording the date, time, location, identity and duration of all patient registrations.

49. A patient registration method comprising the steps of: collecting user data; eliciting user authorization and acknowledgment; storing the collected information; and organizing the information.

50. The registration method according to claim 49, wherein said collecting step is defined as requesting and receiving personal information from the user.

51. The registration method according to claim 50, wherein said inputting step includes using digital forms implemented on a PC or tablet device.

52. The registration method according to claim 49, wherein said eliciting step includes requesting and receiving a digital signature on a Tablet/Pen-Tablet PC device.

53. The registration method according to claim 49, wherein said storing step is defined as communicating the information to a central server.

54. The registration method according to claim 53, wherein said storing step is further defined as recording the information on the server.

55. The registration method according to claim 49, wherein said organizing step is defined as associating the information with other relevant records.

56. A patient authorization method, comprising the steps of: obtaining secured, digital, non-modifiable signatures; indexing the digital signatures; retrieving the signatures; and transferring the signatures.

57. The authorization method according to claim 56, wherein said obtaining step is defined as requesting and receiving a digital signature on a Tablet/Pen-Tablet PC device.

58. The authorization method according to claim 56, wherein said indexing step is defined as associating the digital signature with a patient's record.

59. The authorization method according to claim 56, wherein said indexing step includes storing the digital signature on a central server with the patient's electronic record.

60. The authorization method according to claim 56, wherein said retrieving step is defined as recalling the digital signatures stored on the central server.

61. The authorization method according to claim 60, wherein said retrieving step is further defined as presenting the digital signature graphically.

62. The authorization method according to claim 56, wherein said transferring step is defined as transferring the digital signatures from one location to another.

63. An information collecting method comprising the steps of: presenting prior user data; determining the relevant information to collect; collecting user data; eliciting user authorization and acknowledgment; storing the collected information; and organizing the information.

64. The information collecting method according to claim 63, wherein said presenting step is defined as displaying previously known user information.

65. The information collecting method according to claim 64, wherein said presenting step is further defined as eliciting modifications of existing user information.

66. The information collecting method according to claim 63, wherein said determining step includes calculating what relevant information should be collected.

67. The information collecting method according to claim 66, wherein said determining step further includes periodic automatic updating of patient information.

68. The information collecting method according to claim 63, wherein said collecting step is defined as requesting and receiving information from the user.

69. The information collecting method according to claim 63, wherein said eliciting step includes requesting and receiving a digital signature on a Tablet/Pen-Tablet PC device.

70. The information collecting method according to claim 63, wherein said storing step is defined as communicating and recording the information to a central server.

71. The information collecting method according to claim 63, wherein said organizing step is defined as associating the information with other relevant records.

72. The information collecting method according to claim 71, wherein said organizing step is further defined as highlighting newly entered information.

73. A workflow regulating method, comprising the steps of: recording patient information; retrieving stored information; managing patient information; and ensuring the integrity of patient information.

74. The workflow regulating method according to claim 73, wherein said recording step is defined as receiving and recording patient information to a central server.

75. The workflow regulating method according to claim 73, wherein said retrieving step is defined as retrieving and presenting previously stored patient data.

76. The workflow regulating method according to claim 73, wherein said managing step includes monitoring the integrity of the connection between remote PC's and the central server.

77. The workflow regulating method according to claim 73, wherein said managing step further includes replicating and synchronizing the information communicated between the remote device and the central server.

78. The workflow regulating method according to claim 73, wherein said managing step further includes detecting data conflicts.

79. The workflow regulating method according to claim 73, wherein said managing step further includes assigning conflicts to the appropriate defined resource.

80. The workflow regulating method according to claim 73, wherein said ensuring step is defined as managing remote backup of data and configuration information.

81. An information indexing method, comprising the steps of: recording the date, time, location, identity, and duration of all patient registrations; and associating such information with a patient's record.

82. An electronic client registration system comprising registration means for collecting client data, authorization means for eliciting client authorization and acknowledgment, and indexing means for organizing and associating the collected information.

83. An electronic workflow regulation system, comprising storage means for recording client information, retrieval means for accessing stored information, management means for updating and organizing client information, and backup means for ensuring the integrity of client information.
